(19) United States
(12) Patent Application Publication
(10) Pub. No.: US 2012/0305847 A1
(43) Pub. Date: Dec. 6, 2012

(54) HEAT EXCHANGER AND METHOD OF OPERATING A HEAT EXCHANGER

(76) Inventor: Thomas Paul Von Kossak-Glowczewski, Gummersbach (DE)

(21) Appl. No.: 13/522,746

(22) PCT Filed: Jan. 19, 2011
(86) PCT No.: PCT/EP11/50651

§ 371 Date: Aug. 22, 2012

(30) Foreign Application Priority Data
Jan. 21, 2010 (EP) 1015138.0

(51) Int. Cl. F28F 27/00; C09K 3/00; B01J 19/00

(52) U.S. Cl. 252/372; 165/96; 422/198

(57) ABSTRACT

A method of operating a heat exchange device downstream of a gasification reactor for the partial combustion of a carbonaceous feed for the production of synthetic gas. The produced synthetic gas flows through the heat exchange device with a flow velocity which is adjusted as a function of the composition and/or particle size of fouling components carried by the synthetic gas, in particular fly ash. A heat exchange device comprising a channel surrounding one or more heat exchange surfaces and having an adjustable flow-through capacity. The heat exchange surfaces can, e.g., be cylindrical and be coaxially nested, the inner heat exchange surface defining an inner channel with one or more closing members, which are moveable between a closing position and an opening position.

The present invention relates to a method of operating a heat exchange device downstream of a gasification reactor for the partial combustion of a carbonaceous feed for the production of synthetic gas. The invention also relates to the heat exchanger as such.

In gasification processes for the production of synthetic gas, or syngas, carbonaceous feedstock is partially oxidised in a gasification reactor. Initially, the produced syngas typically has a temperature of 1300-1600° C. When the syngas leaves the reactor the hot syngas is quenched to temperatures between 1000-700° C. and is then transported to a cooler section comprising one or more heat exchange devices.

U.S. Pat. No. 5,482,110 discloses a heat exchanger for cooling syngas from a partial combustion reactor comprising nested heat exchange surfaces carried by a support in a channel. The heat exchange surfaces are formed by meandering, helically wound or vertical tubes interconnected to form a gastight wall. To guide the hot gas as much as possible along the heat exchange surfaces, the central passage through the central heat exchange surface is closed off by one or more plates. Hot gas passes along the heat exchange surfaces typically at a velocity of about 4-12 m/s. When it leaves the gasifier unit, the hot syngas typically comprises fly ash generated as a by-product during the gasification process. The type of fly ash, its fouling behaviour and its effects on erosion of the heat exchanger materials vary with the type and composition of the used carbonaceous feed. While gasification reactors are typically designed for a specific production rate and process flow velocity, they can be used for only a limited range of feed types to prevent unacceptable fouling of the heat exchangers.

It is an object of the present invention to provide a heat exchanger which can be used for cooling syngases made from a broad range of types of carbonaceous feed while fouling on the one hand and erosion effects on the other hand are kept at acceptable levels.

The object of the invention is achieved by a method of operating a heat exchange device downstream of a gasification reactor for the partial combustion of a carbonaceous feed for the production of synthetic gas, wherein the produced synthetic gas flows through the heat exchange device with a flow velocity which is adjusted as a function of the composition and/or particle size of fouling components carried by the synthetic gas. While low flow velocities typically result in increased fouling, high flow velocities, on the other hand, result in increased erosion of the material of the heat exchanger. With the method according to the present invention, it is possible to balance erosion and fouling effects by adjusting the flow velocity to an optimum which may vary with the type of carbonaceous feed.

When a synthetic gas is produced by partial combustion of a carbonaceous feed in a gasifier unit, the flow velocity can for example be adjusted as a function of the composition of the carbonaceous feed and/or the composition of the fly ash borne by the synthetic gas. Alternatively, or additionally, the flow velocity can be adjusted as a function of the average fly ash particle size. It has been found that these parameters have a strong influence on the fouling behaviour of syngas and erosion effects. The flow velocity can be for example be accelerated proportionally with decreasing average particle size of the fly ash. Alternatively, if a certain type of carbonaceous feed is used, e.g. coal from a certain batch or source, a flow velocity can be chosen on basis of previous experiences with coal of the same specific type or source.

The method according to the invention can be carried out with any suitable type of heat exchanger, such as for instance fire tube boilers, e.g., with an internal by-pass. The method can particularly be carried out with a heat exchange device comprising a channel surrounding one or more heat exchange surfaces, the channel having an adjustable flow-through capacity. By adjusting the flow-through capacity, the flow velocity of the synthetic gas can effectively be controlled and adjusted to balance erosion and fouling effects.

The channel of the heat exchange device can for example surround a number of coaxially nested heat exchange surfaces of a closed geometry, the inner heat exchange surface defining an inner channel with one or more closing members, wherein the one or more closing members are moveable between a first position wherein the closing member blocks the inner channel and a second position wherein the inner channel is at least partly open. The closed geometry, or tubular geometry, can for example be cylindrical, but may, alternatively, also be of any other type of tubular geometry, e.g., a geometry showing a square, polygonal or elliptical plan view. The heat exchange surfaces can be made of parallel tubular lines, e.g., vertical or spirally wound tubular lines interconnected, e.g., welded, to form a gastight wall, e.g., as a tube-stay-tube or fin-tube construction. The tubular lines can be connected to a coolant supply and a coolant discharge.

Optionally, the channel wall surrounding the nested heat exchange surfaces can also be formed by gastight connected spirally wound or vertical parallel tubular lines, which can also be connected to a coolant supply and a coolant discharge. Such a channel wall can for instance be surrounded by a pressure vessel wall.

By opening the inner channel confined by the inner one of the nested heat exchange surfaces, the cross sectional passage area of the flow path is substantially increased and the flow velocity of the hot gas product is reduced. If the closing member closes off the passage, the cross sectional passage area of the flow path is reduced thus increasing the flow velocity of the hot gas product.

The adjustability of the flow velocity is further increased if the closing members can be moved to at least one intermediate position between the first and second position for partly blocking the inner channel.

Preferably, the closing members can be opened or closed gradually.

In a specific embodiment, the one or more closing members are pivotable about an axis perpendicular to the longitudinal axis of the nested heat exchange surfaces. As a control mechanism, the closing member can for instance be coupled to a shaft extending through the outer channel wall. The shaft can be controlled manually or automatically, e.g., responsive to measurements of flow velocity and/or gas temperature, if so desired. A flexible drive transmission can be used to overcome differences in thermal expansions by the various parts crossed by the control mechanism, if so desired.

To reduce the risk of heat induced damage the closing member can for instance comprise one or more cooling channels operatively connected to a coolant supply and a coolant discharge respectively. A suitable example of a water cooled control member is disclosed in German patent application DE 39 13 422, where it is used in a by-pass line for temperature control of an end-product.

The heat exchange device is particularly useful as a section of a gasification reactor for the production of synthetic gas by partial combustion of a carbonaceous feed.

The present invention will be elucidated with reference to the figures wherein:

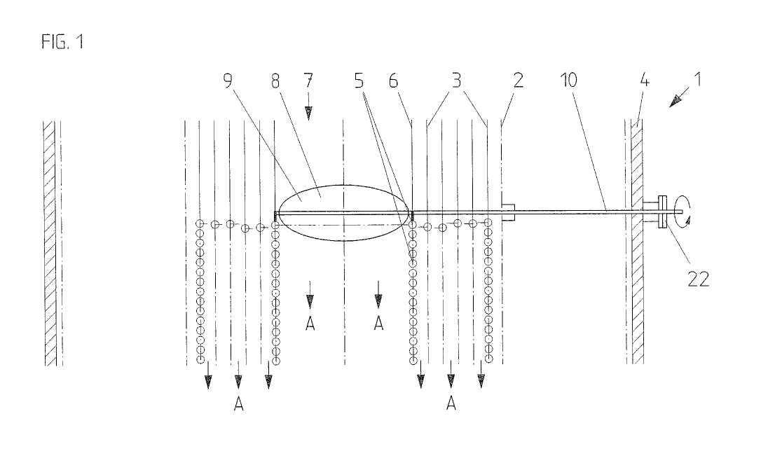

FIG. 1: shows schematically a heat exchange device according to the present invention;

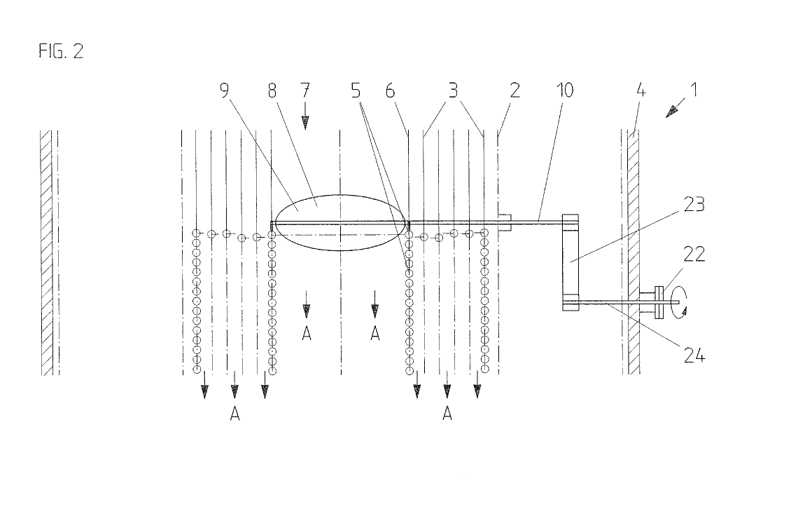

FIG. 2: shows an alternative embodiment of a heat exchange device according to the present invention;

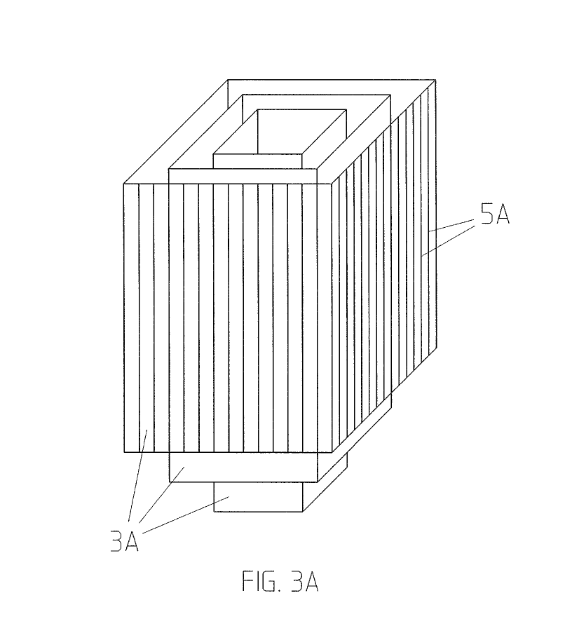

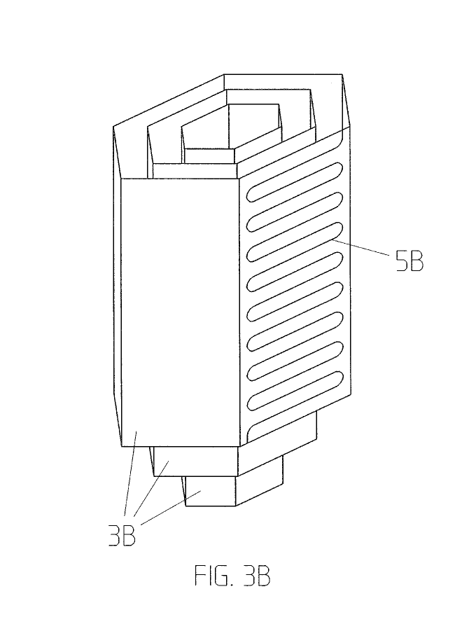

FIG. 3A: shows an alternative heat exchange surface for a heat exchange device according to the invention;

FIG. 3B: shows a further alternative heat exchange surface for a heat exchange device according to the invention;

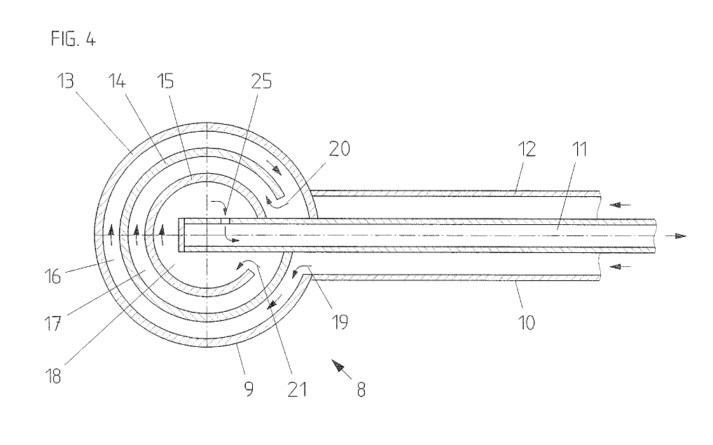

FIG. 4: shows a control member for the device in FIG. 1 or 2.

FIG. 1 shows schematically in longitudinal cross section a heat exchange device 1 of a cooler section of a gasification reactor (not shown) for the production of synthetic gas by partial combustion of a carbonaceous feed, such as pulverized coal. The heat exchange device 1 comprises an outer cylindrical channel wall 2 surrounding a number of nested, coaxially arranged cylindrical heat exchange surfaces 3. The outer channel wall 2 is coaxially arranged with the nested surfaces 2 and is surrounded by a coaxial pressure vessel wall 4. The outer channel wall 2 and the heat exchange surfaces 3 are formed by parallel tubular lines 5, e.g., spirally wounded or vertical lines, which are interconnected to form a gastight structure, so gas flowing between two heat exchange surfaces 3 cannot escape to the space between two other heat exchange surfaces 3. The inner heat exchange surface 6 defines an inner channel 7. A closing member 8 comprises a rotatable circular flap 9 connected to a radially extending shaft 10 which is perpendicular to the longitudinal axis of the nested heat exchange surfaces 3. The shaft 10 extends through the nested heat exchange surfaces 3, the outer channel wall 2, and the pressure vessel wall 4, where it can be actuated manually using a control mechanism 22.

Gas flows through the heat exchange surfaces 3 in the direction indicated in FIG. 1 by arrows A. By turning the shaft 10 the circular body 9 is gradually moveable between a first, horizontal position to block the inner channel 7 and a second position wherein the inner channel 7 is open and unblocked. When the inner channel 7 is blocked, gas can only flow between the heat exchange surfaces 3. By opening the inner channel 7 the cross sectional flow area is increased and the flow velocity is proportionally reduced.

FIG. 2 shows an alternative embodiment of a heat exchange device according to the present invention. Where the parts are the same as in the embodiment in FIG. 1, the same reference numbers are used. Here the shaft 10 does not extend through the pressure vessel wall 4, but a pulley 23 connects it to a counter shaft 24, which extend through the pressure vessel wall 4 to the control mechanism 22. Such a transmission can be used to prevent mechanical stresses induced by thermal expansion in the various parts of the construction. The coaxially nested heat exchange surfaces 3 in the embodiments of FIGS. 1 and 2 are cylindrical. However, if so desired any other type of closed geometry can be used. In FIG. 3A the nested heat exchange surfaces 3A have a square cross section and are formed by vertical parallel tubes 5A, interconnected to form a gastight wall. At their lower sides, the heat exchange surfaces 3A extend over a distance beyond the lower edge of an adjacent outer heat exchange surface 3A. This enables cleaning of each of the heat exchange surfaces by a rapper device or the like.

FIG. 3B shows a further alternative, where the heat exchange surfaces 3B are polygonal. The heat exchange surfaces 3B are built of meandering tubular lines 5B interconnected to form a gastight structure.

FIG. 4 shows in more detail the closing member 8 with a cooling system. It is noted that in other possible embodiments uncooled closing members can be used, if so desired. The shaft 10 comprises an inner tubular line 11 and a coaxially arranged outer tubular line 12. The circular body 9 comprises three concentric cylindrical walls 13, 14, 15, aligned about an axis which is perpendicular to the longitudinal axis of the shaft 10. The spaces 16, 17, 18 between the concentric walls 13, 14, 15 are closed by two lateral circular flat end walls (not shown). The inner tube 11 of the shaft 10 extends into the space enclosed by the inner concentric wall 15. Openings 19, 20, 21 in the concentric walls 13, 14, 15 are arranged to define a meandering flow path for coolant, in particular water, supplied via the outer tubular line 12. The water leaves the space enclosed by the inner concentric wall 15 via a lateral opening 25 in the inner tubular line 11 of the shaft 10. The tubular

1. A method of operating a heat exchange device downstream of a gasification reactor for the partial combustion of a carbonaceous feed for the production of synthetic gas, wherein the produced synthetic gas flows through the heat exchange device with a flow velocity which is adjusted as a function of the composition and/or particle size of fouling components carried by the synthetic gas.

2. A method according to claim 1 wherein the fouling components include fly ash and wherein the flow velocity is adjusted as a function of the composition and/or particle size of the fly ash.

3. A method according to claim 1 wherein the hot gas flows along one or more coaxially nested heat exchange surfaces, and wherein the flow velocity is adjusted by adjusting the passage opening enclosed by one or more of the heat exchange surfaces.

4. A method according to claim 3 wherein the flow velocity is adjusted by adjusting the passage opening enclosed by on the central heat exchange surface.

5. A method according to claim 3 wherein the passage opening is adjusted by rotating a flap between a first position wherein the flap is parallel to the gas flow direction, and a second position where it closes off the passage opening.

6. A method according to claim 5 wherein the flap is cooled by a coolant.

7. A heat exchange device comprising a channel wall surrounding one or more heat exchange surfaces, the channel having an adjustable flow-through capacity.

8. A heat exchange device according to claim 7 wherein the channel wall surrounds a number of coaxially nested heat exchange surfaces of a closed geometry, the inner heat exchange surface defining an inner channel with one or more closing members, wherein the one or more members are moveable between a first position wherein the closing member blocks the inner channel and a second position wherein the inner channel is at least partly open.

9. A heat exchange device according to claim 8 wherein the closing members can be moved to at least one position between the first and second position for partly blocking the inner channel.

10. A heat exchange device according to claim 8 wherein the one or more closing members are pivotable about an axis perpendicular to the longitudinal axis of the nested heat exchange surfaces.

11. A heat exchange device according to claim 8 wherein the one or more closing members (8) are coupled to a shaft (10) extending through the channel wall (2).

12. A heat exchange device according to claim 8 wherein the one or more closing members comprise one or more cooling channels operatively connected to a coolant supply and a coolant discharge respectively.

13. A heat exchange device according to claim 1 8 wherein the closed geometry is cylindrical.

14. A heat exchanger according to claim 8 wherein the nested heat exchange surfaces are formed by meandering, helically wound or vertical tubes interconnected to form a gastight wall structure.

15. A gasification reactor for the production of synthetic gas by partial combustion of a carbonaceous feed comprising a cooler section with one or more heat exchanging devices according to claim 8.
